(19) United States
(12) Patent Application Publication
(10) Pub. No.: US 2013/0048019 A1
(43) Pub. Date: Feb. 28, 2013

(54) METHOD OF REMOVING CHEWING GUM RESIDUES FROM SUBSTRATES

(71) Applicants: Kenneth Seddon, Belfast (GB); Manuela Gilea, Belfast (GB); Martyn Earle, Belfast (GB)

(72) Inventors: Kenneth Seddon, Belfast (GB); Manuela Gilea, Belfast (GB); Martyn Earle, Belfast (GB)

(21) Appl. No.: 13/581,048

(22) PCT Filed: Feb. 28, 2011
(86) PCT No.: PCT/GB2011/000280

§ 371 Date: Nov. 6, 2012

(30) Foreign Application Priority Data
Feb. 27, 2010 (GB) 1003313.2

(51) Int. Cl. C11D 7/60; B08B 5/04; B08B 3/08; B08B 1/00

(52) U.S. Cl. 134/6; 510/200; 134/21; 134/34

(57) ABSTRACT

The present invention relates to a method of removing chewing gum and residues thereof from substrates using chewing gum modifying compositions comprising oxidising reagents and one or more oxidation catalysts.

The present invention relates to a method of removing chewing gum and residues thereof from substrates using chewing gum modifying compositions comprising oxidising reagents.

It is well known that chewing gum residues have a tendency to stick firmly to substrates with which they come into contact. Chewing gum residues on pavements are unsightly and, as the gum residue is substantially non-biodegradable, the residues tend to accumulate over time.

Conventional chewing gum compositions are a complex mixture of ingredients which comprise a water-soluble portion, which typically comprises sweeteners, flavourings, food colourings and fillers, and a water-insoluble portion, referred to as “gum base”, which typically comprises elastomers (which provide the chewy, cohesive texture of the gum), plasticizers, softeners and waxes, together with auxiliaries such as emulsifiers and antioxidants. The gum base provides the textural and masticatory properties of chewing gum. It is the insoluble gum base which remains after the gum has been chewed, and thus it is this part of the gum which is responsible for the occurrence of unsightly deposits on pavements.

The amount of the various ingredients in a chewing gum composition depends on the type of gum. For instance, bubble gums generally contain lower amounts of gum base, e.g. 15 to 20% by weight, whereas normal chewing gums typically contain 25 to 33% by weight of gum base, although they may contain as much as 60% by weight of gum base.

All types of chewing gum, including bubble gum, are considered to be within the scope of the present invention. For instance, the present invention is considered to include chewing gums containing between 10 and 75% by weight of gum base. Historically, gum base has been derived from natural gums such as chicle. Chicle is a gum derived from the sap of the Sapodilla tree, and is a natural polysaccharide elastomer of xylose in a (1→4)-β-D-xylopyranose conformation substituted with D-glucoronic acid and L-arabinose. Other natural gums that are, or have been, used in chewing gums include jelutong, sorva, gutta percha, gutta hang kang, niger gutta, gutta kataiu, chilte, chiquibul, massaranduba balata, massaranduba chocolate, nispero, leche, caspi and rosidinha.

The use of natural gums in chewing gum has diminished in recent years, due to scarcity and inconsistency of the crops, and the development of synthetic elastomers which give the chewing gum improved flavour and texture. Examples of synthetic elastomers used in chewing gum compositions are polyisoprene (1), polybutadiene (2), styrene-butadiene copolymers (3), polyisobutylene (4), polyvinylacetate (5), polyethylene (6), as well as isobutylene-isoprene copolymer, vinyl acetate-vinyl laurate copolymer, crosslinked polyvinyl pyrrolidone, polymethylmethacrylate, copolymers of lactic acid, polyhydroxyalkanoates, plasticized ethylcellulose, polyvinyl acetatephthalate and combinations thereof.

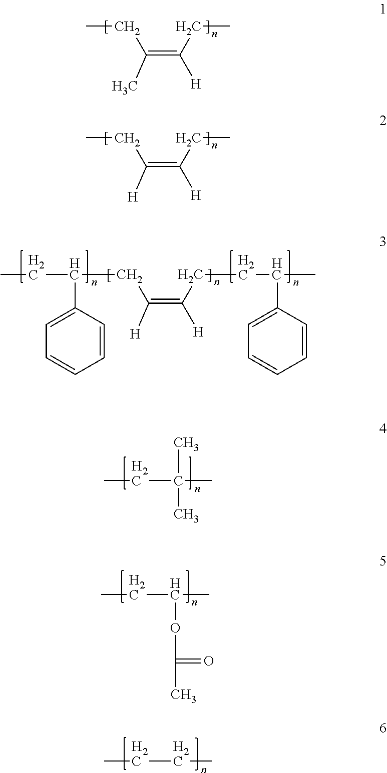

The amount of elastomer used in the gum base depends on a variety of factors, including the type, or types, of elastomer used, the desired consistency of the gum, and the other components of the gum base. A typical gum base composition comprises between 5 and 80% elastomer by weight, more commonly between 10 and 60% by weight, and most commonly between 20 and 40% by weight. A notable feature of many of these elastomers is a saturated hydrocarbon backbone that is difficult to break down. For this reason, the elastomer compounds found in gum bases are generally considered to be non-biodegradable.

The gum base also includes plasticizers and softeners, which are used to soften the elastomer component. Many plasticizers are suitable for use in gum bases, including terpene resins such as polymers of alpha-pinene or beta-pinene, methyl, glycerol and pentaerythritol esters of rosins, and modified rosins such as hydrogenated, dimerized and polymerized rosins, and mixtures thereof. Specific examples of plasticizers include the pentaerythritol esters of partially hydrogenated wood and gum rosins, the pentaerythritol esters of wood and gum rosins, the glycerol esters of wood rosin, the glycerol esters of partially dimerized wood and gum rosins, the glycerol esters of polymerized wood and gum rosins, the glycerol ester of tall oil rosin, the glycerol esters of wood and gum rosins and partially hydrogenated wood and gum rosins, the methyl esters of partially hydrogenated wood and gum rosins, and mixtures thereof. Other plasticizers that may be found in gum include glycerol triacetate and polyvinyl alcohol. Typically, plasticizers constitute around 50% by weight of the gum base composition. The softeners used in gum bases are usually derived from natural fats and oils, and include tallow, cocoa butter, sunflower oil and palm oil. Artificial softeners include various synthetic glycerol esters and triglycerides, such as triacetin. The softener may comprise up to around 20% by weight of the gum base composition.

In addition, the gum base may include waxes such as paraffin waxes to improve the elasticity of the gum base and to soften the elastomeric mixture. Typical waxes used in chewing gum have a melting point between 45 and 60° C. and are present in the gum base in an amount of up to 10% by weight, more preferably between 5 and 10% by weight. In some cases, the gum base may also include higher melting waxes, such as petroleum wax or beeswax, which are typically present in the gum base in amounts of up to 5% by weight.

When chewing gum residues are discarded onto pavements, it is the elastomers, resins and wax components of the gum base that are responsible for the adhesive effect of the residues. The waxes promote wetting of the substrate by the soft plastic mass of gum remaining after chewing. As substrate wetting occurs, the gum residue spreads over the substrate and the elastomer and resin components of the gum base are then able to interact mechanically with the microporous structure of materials such as paving stones. When chewing gum residues are dropped on a pavement substrate, e.g. sandstone, it is thought that the polymeric chains of the elastomer and the resin components of the gum base effectively become entangled in the cage-like structure of the sandstone, forming a strong mechanical link which is the physical basis of the adhesion of gum residues to pavements.

Current methods for removing chewing gum from pavements are generally time consuming and costly, and usually need to be carried out by specialist companies. Most methods of removing gum residues work by disrupting the non-covalent interactions between the gum and the substrate using high pressure water or steam. However, these techniques are costly due to the large amounts of energy required to generate high pressure water or steam; they are abrasive and may therefore cause damage to the grouting between paving slabs and to soft substrates such as tarmac; and they cause inconvenience to the public. For such reasons, the use of high pressure water or steam cleaning systems is generally confined to periodic programs for “deep cleaning” street surfaces, usually taking place at night, and is inappropriate for day-to-day cleaning operations. In addition, such techniques are often inappropriate for use in confined areas, interior surfaces, and areas where the use of large quantities of water, steam or chemicals may be restricted.

An alternative approach is to dissolve the gum using organic solvents. However, most organic solvents that could be used for this purpose are poisonous, flammable or harmful to the environment and are therefore hazardous to operators and unsuitable for use in public places. Chewing gum is hydrophobic and therefore usually considered to be incompatible with aqueous removal compositions.

Another technique that is sometimes used to remove chewing gum residues involves applying a cryogenic substance, such as dry ice or liquid nitrogen, to the residue. This promotes an elastic-to-glass transition of the polymer in the gum residue. The glass is an ordered, rigid and brittle structure with the polymer chains in an aligned crystalline state. The brittle gum residue can then be fragmented by mechanical means and then swept or vacuumed from the substrate. Obvious disadvantages of such methods are the cost of cryogenic substances, the potential risk to operators using such substances, intensive labour requirements, and inconvenience to the public.

One approach to the problem of chewing gum deposits has been to develop chewing gums with increased biodegradability or decreased stickiness. However, there has been little progress in this area, mainly because the commercially important features of chewing gum, such as texture, flavour retention and shelf life, tend to be impaired when the chemical structure of the gum base is changed.

Accordingly, there is a clear need for alternative methods for dealing with contamination by chewing gum residues. Desirable characteristics of any new method for removing chewing gum residues include: reduced cost; reduced need for specialist equipment and specially trained operators; reduced energy and water requirements; reduced labour requirements; reduced risk to operators, the public and the environment; and reduced inconvenience to the public. Accordingly, any composition to be used in such a method will desirably be: non-toxic; non-flammable; environmentally friendly; fast acting; effective at low temperatures; easy to use without special training; and easy to rinse away with low pressure water leaving no residues that require further cleaning.

In a first aspect, the present invention provides a method of modifying a chewing gum residue so as to ease removal of the chewing gum residue from a substrate, the method comprising applying to the chewing gum residue a chewing gum modifying composition comprising one or more oxidising reagents and one or more oxidation catalysts, and wherein the chewing gum modifying composition does not comprise an ionic liquid.

As used herein, the term “ionic liquid” as used herein refers to a liquid that is capable of being produced by melting a salt, and when so produced consists solely of ions. An ionic liquid may be formed from a homogeneous substance comprising one species of cation and one species of anion, or it can be composed of more than one species of cation and/or more than one species of anion. Thus, an ionic liquid may be composed of more than one species of cation and one species of anion. An ionic liquid may further be composed of one species of cation, and one or more species of anion. Still further, an ionic liquid may be composed of more than one species of cation and more than one species of anion. The term “ionic liquid” as used herein includes compounds having both high melting points and compounds having low melting points, e.g. at or below room temperature (i.e. 0 to 25° C.). The latter are often referred to as “room temperature ionic liquids” and often derived from organic salts having pyridinium, imidazolium, ammonium or phosphonium cations comprising alkyl-substituted cationic nitrogen or phosphorus atoms. However, ionic liquids may also be derived from a number of other heterocyclic compounds, as would be appreciated by a person of skill in the art.

The exact mechanisms by which the oxidising reagent(s) and oxidation catalyst(s) facilitates the removal of chewing gum residues are believed to be complex and are not known in detail. Without wishing to be bound by any particular theory, however, it is thought that at least three processes are involved: (i) oxidation reactions break down the polymeric components of the gum residue into fragments of lower molecular weight; (ii) heat generated in the oxidation reaction further softens the gum residue, disrupting the non-covalent interactions within the gum matrix (referred to herein as polymer-polymer interactions), increasing the mobility of the polymer chains in the gum residue and enabling the oxidising reagent to further penetrate the gum matrix; and (iii) release of gases during the oxidation reaction further disrupts the polymer-polymer interactions and the interactions between the gum matrix and the substrate to which it is attached (referred to herein as polymer-substrate interactions). The resulting residue has reduced adhesiveness and is also softer and more fluid, making it easier to remove from the substrate.

In accordance with the present invention, the one or more oxidising reagents may be selected from hydrogen peroxide, organic hydroperoxides, organic peroxyacids, organic peroxyacid salts, and dioxiranes.

More preferably, the one or more oxidising reagents are selected from hydrogen peroxide, organic hydroperoxides having the formula ROOH, organic peroxyacids having the formula RCO₃H or salts thereof, wherein R is a C₁ to C₁₀ alkyl group or a C₆ to C₁₀ aryl group.

Still more preferably, the one or more oxidising reagents are selected from hydrogen peroxide or organic hydroperoxides having the formula ROOH, wherein R is as defined above.

For example, the one or more oxidising reagents may be selected from hydrogen peroxide and tert-butyl hydroperoxide. Most preferably, the oxidising reagent is hydrogen peroxide.

The total concentration of the one or more oxidising reagents in the chewing gum modifying composition is preferably in the range of from 1.0 to 50 mol·dm⁻³, more preferably in the range of from 2.0 to 25 mol·dm⁻³, and most preferably in the range of from 5.0 to 10 mol·dm⁻³.

Preferably, the one or more oxidation catalysts are selected from lanthanide salts and transition metal salts. For example, the one or more oxidation catalysts may be selected from Fe(II), Fe(III), Mn(VII), Mn(VI), Mn(IV), Mo(VI), Co(II), Zr(IV), Ce(IV), and Ni(II) salts.

Preferably, the one or more oxidation catalysts are selected from Fe(III), Mn(VII), and Mn(IV) salts, for example Fe(AOT)₃, FeCl₃, Fe₂(SO₄)₃, MnO₂, and KMnO₄ (where AOT represents bis(2-ethylhexyl)sulfosuccinate).

Most preferably, the one or more oxidation catalysts are selected from Fe(AOT)₃ and KMnO₄.

The total concentration of the one or more oxidation catalysts in the chewing gum modifying composition is preferably in the range of from 0.001 to 1.0 mol·dm⁻³, more preferably in the range of from 0.005 to 0.5 mol·dm⁻³, and most preferably in the range of from 0.01 to 0.1 mol·dm⁻³. The relative concentrations of the oxidising agents and oxidation catalysts depend on a number of factors, including the nature of the oxidising agents and oxidation catalysts, as well as the timescale required for the gum to be removed. Suitable relative concentrations for each combination of oxidising agents and oxidation catalysts can readily be determined by a person of skill in the art by routine testing methods. However, in general, the concentration of the oxidation catalysts will be in the range of from 0.001 to 5.0 mol %, and more preferably in the range of from 0.01 to 1.0 mol % of the concentration of the oxidising agents

In accordance with this aspect of the invention, the chewing gum modifying composition may further comprise one or more gelling agents. Preferred gelling agents are hydrophilic, and suitable gelling agents are discussed below.

In a further aspect, the present invention provides a method of modifying a chewing gum residue so as to ease removal of the chewing gum residue from a substrate, the method comprising applying to the chewing gum residue a chewing gum modifying composition comprising one or more oxidising reagents and one or more gelling agents, and wherein the chewing gum modifying composition does not comprise an ionic liquid.

In accordance with this aspect of the invention, the one or more oxidising reagents and their concentration in the chewing gum modifying composition are preferably as defined above.

The chewing gum modifying compositions used in the methods of the present invention are preferably in the form of an aqueous and/or alcoholic solutions and/or suspensions. Suitable alcohols include methanol, ethanol, propanol and butanol, as well as longer-chain alcohols such as octanol. Most preferably, the chewing gum modifying composition is in the form of an aqueous solution or suspension. Water is compatible with the oxidising reagents and oxidation catalysts mentioned above. In addition, water is non-toxic, non-flammable, and therefore safe to use in public areas. Thus, in a preferred embodiment, the chewing gum modifying compositions are substantially alcohol-free.

It is preferred that the chewing gum modifying compositions used in the methods of the present invention have a relatively high viscosity, for example a viscosity in the range of from 5,000 to 50,000 cP at 25° C. Particularly preferred chewing gum modifying compositions in accordance with the present invention may have viscosities of at least about 15,000 cP at 25° C., or at least about 25,000 cP at 25° C., or even at least about 35,000 cP at 25° C.

Chewing gum modifying compositions having viscosities above 5,000 cP at 25° C. have gel-like consistencies and are capable of being applied as a coating on the surface of a chewing gum residue, e.g. for spot application of the composition to individual gum residues. In this way, the oxidising reagent(s) and the oxidation catalyst(s) (where present) remain in contact with the gum residue, maximising the extent of reaction possible and reducing waste of reagents. Further, the high viscosities of the chewing gum modifying compositions prevents the oxidising reagent(s) and the oxidation catalyst(s) (where present) from being absorbed by the substrate.

Gelling agents suitable for use in the methods of the present invention may, for example, be selected from silica, alumina, clays, and organic polymers.

Examples of suitable gelling agents for use in the methods of the present invention include, among others, fumed silica, precipitated silica, fumed alumina, precipitated alumina, attapulgite clay, bentonite clay, hectorite clay, smectite clay, montmorillonite, polyethylene imine, polyethylene oxide, polyacrylic acid, and polyvinyl alcohol.

Particularly preferred gelling agents for use in the methods of present invention are fumed silica and polyethylene imine (PEI).

Where a gelling agent is used, the concentration of the gelling agent in the chewing gum modifying composition is preferably in the range of from 1 to 30 weight percent, more preferably from 1 to 20 weight percent and most preferably from 1 to 10 weight percent.

The chewing gum modifying compositions used in the methods of the present invention may further comprise one or more thickening agents and/or one or more foaming agents to obtain gel-like consistencies.

The chewing gum modifying composition comprising one or more thickening agents and/or one or more foaming agents have reduced movement away from a target chewing gum residue when applied as a coating (see comments above regarding gel-like consistencies). This improves contact of the composition with the chewing gum residue, maximising the extent of reaction thereby minimising both the amount of oxidising reagent and oxidation catalyst applied to the target chewing gum residue and the number of applications of the chewing gum modifying composition to the target chewing gum residue.

The thickening agent may comprise a polymer thickening agent and/or a silicate thickening agent. Preferred polymer thickening agents are polyethers, such as polyglycols (for example, polyethylene glycols and polypropylene glycols) and polyglycol esters, and polyamines (for example, polyethylene amine). Preferably the polymer thickening agent is a polyglycol, most preferably polyethylene glycol.

Preferred silicate thickening agents include metasilicates (SiO₃²⁻), orthosilicates (SiO₄⁴⁻), sorosilicates (Si₂O₇⁶⁻), and mixtures thereof. The silicate thickening agent may be an alumino silicate. Preferably the silicate thickening agent has a metal cation. The metal cation may be selected from the group consisting of group I metals (for example Li, Na and K), group II metals (for example Be, Mg, Ca and Ba) and transition metals (for example Cr, Mn, Fe, Zn and Zr). Preferably, the silicate thickening agent is a sodium silicate, most preferably sodium metasilicate. Powdered glass may also be used as the thickening agent. The powered glass may consist of silica.

The total amount of thickening agent(s) used in the chewing gum modifying composition may range from about 0.01 to about 100 g per litre, preferably from about 0.05 to about 50 g per litre, and more preferably from about 0.1 to about 10 g per litre.

The foaming agent may comprise a foaming surfactant. These include non-ionic surfactants, cationic surfactants, anionic surfactants, zwitterionic surfactants, surfactants that contain both anionic and cationic components, and combinations thereof. Preferably the foaming surfactant comprises an anionic surfactant, such as a sulfate surfactant. The sulfate surfactant may be selected from the group consisting of sodium laureth sulphate, sodium lauryl sulphate, ammonium lauryl sulfate, sodium myreth sulfate, sodium pareth sulfate and combinations thereof. Preferably, the sulfate surfactant is a sodium sulfate surfactant, most preferably sodium laureth sulphate or sodium lauryl sulphate.

The total amount of foaming agent(s) used in the chewing gum modifying composition may range from about 0.01 to about 100 g per litre, preferably from about 0.05 to about 50 g per litre, and more preferably from about 0.1 to about 10 g per litre.

A preferred chewing gum modifying composition comprises both a thickening agent and a foaming agent. A synergistic effect may be displayed by the combination of a thickening agent and a foaming agent. In one example, the composition may comprise at least one of the thickening agents selected from polyethylene glycol and sodium metasilicate, together with at least one of the foaming agents selected from sodium laureth sulfate and sodium lauryl sulfate.

The viscosity of a chewing gum modifying composition comprising one or more thickening agents and/or one or more foaming agents may be increased relative to a chewing gum modifying composition that does not comprise a thickening agent and/or a foaming agent. Suitable viscosities are those described above for gel-like consistencies. For example, the viscosity of a chewing gum modifying composition comprising one or more thickening agents and/or one or more foaming agents may be at least about 35,000 cP at 25° C., or at least about 40,000 cP at 25° C., or even at least about 45,000 cP at 25° C. The viscosity of a chewing gum modifying composition comprising one or more thickening agents and/or one or more foaming agents may be up to 50,000 cP at 25° C.

The chewing gum modifying compositions used in the methods of the present invention may optionally comprise one or more additives selected from the group consisting of surfactants, pH modifiers, emulsifiers, colorants and wetting agents. A wide variety of such additives are known in the art, and the skilled person is capable of selecting suitable additives as necessary for a particular application.

In one embodiment, the chewing gum modifying composition is pre-mixed before application to the chewing gum residue. Preferably, the chewing gum modifying composition is pre-mixed immediately before application of the composition to a chewing gum residue. For example, an aqueous and/or alcoholic solution of the one or more oxidising reagents may be pre-mixed with an aqueous and/or alcoholic suspension of the gelling agent immediately before application to a chewing gum residue. One or both of said solution and said suspension may further comprise a thickening agent and/or foaming agent. In another embodiment, an aqueous and/or alcoholic solution of the one or more oxidising reagents may be pre-mixed with an aqueous and/or alcoholic solution of the one or more oxidising catalysts, wherein one or both of said solutions optionally further comprises a suspension of a gelling agent. One or both of said solutions may further comprise a thickening agent and/or foaming agent.

In a further embodiment, the chewing gum modifying composition is formed in situ.

For example, an aqueous and/or alcoholic suspension of a gelling agent (where present) may be applied to the chewing gum residue first, an aqueous and/or alcoholic solution of the one or more oxidising reagents is applied second, and an aqueous and/or alcoholic solution of the one or more oxidising catalysts (where present) is applied third. Alternatively, the one or more oxidising catalysts may be applied second, and the one or more oxidising reagents applied third. Optionally, a thickening agent and/or foaming agent may be added to one, two or all of said suspension and said solutions.

As a further option, the one or more oxidising agents may be pre-mixed with the aqueous and/or alcoholic suspension of the gelling agent and applied to the chewing gum residue first, followed by an aqueous and/or alcoholic solution of the one or more oxidising catalysts (where present). One or both of said suspension and said solution may further comprise a thickening agent and/or foaming agent. Alternatively, the one or more oxidising catalysts (where present) may be pre-mixed with the aqueous and/or alcoholic suspension of the gelling agent and applied to the chewing gum residue first, followed by an aqueous and/or alcoholic solution of the one or more oxidising agents. One or both of said suspension and said solution may further comprise a thickening agent and/or foaming catalyst. Said pre-mixing preferably takes place immediately before application of the composition to a chewing gum residue.

It will be appreciated that, in order to minimise the volume of the composition, the foaming agent may added immediately before application of the composition to the chewing gum residue.

In addition, if necessary, a further application of the one or more oxidising reagents and/or the one or more oxidation catalysts (where present) may be made after a period of time has elapsed from the first application. The further application may use the same or different oxidising reagent(s) and/or the same of different oxidation catalyst(s) (where present) to the first application.

A preferred form of KMnO₄ for use as an oxidation catalyst in accordance with the present invention is an aqueous solution that comprises KMnO₄ together with K₂CO₃ and NaOH. Preferably, the aqueous solution comprises from 0.1 to 5.0 g KMnO₄, 1.0 to 15 g K₂CO₃, 0.01 to 0.5 g NaOH per 100 mL of water. More preferably, the aqueous solution comprises from 0.5 to 2.0 g KMnO₄, 4.0 to 10 g K₂CO₃, 0.05 to 0.2 g NaOH per 100 mL of water. For example, the aqueous solution may comprise 1.0 g KMnO₄, 7 g K₂CO₃, and 0.08 g NaOH per 100 mL water.

In accordance with the present invention, the chewing gum modifying composition is preferably contacted with the chewing gum residue for a period of from 1 minute to 1 hour, more preferably from 1 minute to 30 minutes, still more preferably from 1 minute to 20 minutes, and most preferably from 1 minute to 10 minutes. However, it will be appreciated that the contact time is dependent on the choice of oxidising reagents, oxidation catalysts (where present), and other components of the chewing gum modifying composition, as well as the age and type of the chewing gum residue. Suitable contacting timescales can be routinely determined by persons of skill in the art simply by monitoring the extent of reaction. As noted above, if necessary, a further application of the one or more oxidising reagents and/or the one or more oxidation catalysts (where present) may be made after a period of time has elapsed from the first application.

In accordance with the present invention, the chewing gum modifying compositions or parts thereof may be applied to chewing gum residues by any method known to the skilled person. Non-limiting examples of such application methods include spraying (e.g. as an aerosol), dipping, brushing and pouring. In a preferred embodiment, the composition or a part thereof can be supplied from a portable reservoir and sprayed under pressure via a spray nozzle mounted on a hand-held spraying lance or on a motorised vehicle. Where the chewing gum modifying composition, or a part thereof, is pre-mixed immediately before application to a chewing gum residue, two or more components of the chewing gum modifying compositions, or part thereof, may be supplied from two or more portable reservoirs and delivered to a mixing zone before being sprayed under pressure via a spray nozzle mounted on a hand-held spraying lance or on a motorised vehicle. Alternatively, the spray nozzle may comprise two or more intake couplings, such that the two or more components of the chewing gum modifying composition, or a part thereof, are mixed simultaneously with passage of the components through the spray nozzle.

Where the chewing gum modifying composition is applied to the chewing gum residue by spraying, any thickening or foaming agent is preferably added immediately before spraying so as to reduce the risk of “clogging up” a spraying apparatus.

The resulting softened chewing gum residues may be removed by techniques including scrubbing, brushing, spraying with low pressure water, or simply allowing the residue to be removed in due course by rainfall. When the chewing gum residue is in a location where public access is required, removal of the softened residue preferably takes place as soon as possible once the chewing gum residue has been sufficiently modified, to avoid the softened gum residues being transferred to the soles of shoes or to clothing.

The methods of the current invention may be used to remove chewing gum residues from a wide variety of substrate materials without damage to the underlying substrate. Examples include stone, concrete, cement, bricks, gypsum plaster, clay, ceramics, glass, asphalt, tarmac, bitumen, metals, wood, lacquer and textiles.

Where the chewing gum modifying composition comprises a gelling agent, the methods of the present invention may comprise applying to a chewing gum residue a chewing gum modifying composition as defined above in admixture with, or sequentially with, a chewing gum modifying composition comprising an ionic liquid and one or more oxidising reagents and/or one or more oxidation catalysts as defined above.

In another aspect, the present invention, provides a chewing gum modifying composition as defined above.

In a preferred embodiment, the chewing gum modifying composition consists of an aqueous and/or alcoholic solution and/or suspension of one or more oxidising agents at a total concentration of from 1.0 to 50 mol·dm⁻³ and one or more oxidation catalysts at a total concentration of from 0.001 to 1.0 mol·dm⁻³, which solution and/or suspension further includes from 0 to 30 weight percent of a gelling agent and from 0 to 10 weight percent of one or more additives selected from the group consisting of surfactants, pH modifiers, emulsifiers, colorants and wetting agents.

The total concentration of the one or more oxidising reagents in the above chewing gum modifying composition is preferably in the range of from 2.0 to 25 mol·dm⁻³, and most preferably in the range of from 5.0 to 10 mol·dm⁻³.

The total concentration of the one or more oxidation catalysts in the above chewing gum modifying composition is preferably in the range of from 0.005 to 0.5 mol·dm⁻³, and most preferably in the range of from 0.01 to 0.1 mol·dm⁻³.

The amount of the gelling agent in the above chewing gum modifying composition is preferably in the range of from 1 to 30 weight percent, more preferably from 1 to 20 weight percent and most preferably from 1 to 10 weight percent.

In a further preferred embodiment, the composition consists of an aqueous and/or alcoholic solution and/or suspension of one or more oxidising agents at a total concentration of from 1.0 to 50 mol·dm⁻³ and one or more oxidation catalysts at a total concentration of from 0.001 to 1.0 mol·dm⁻³, which solution and/or suspension further includes from 0 to 30 weight percent of a gelling agent, from 0 to 100 g per litre of thickening agent, from 0 to 100 g per litre of foaming agent and from 0 to 10 weight percent of one or more additives selected from the group consisting of surfactants, pH modifiers, emulsifiers, colorants and wetting agents.

The total concentration of the one or more oxidising reagents in the above chewing gum modifying composition is preferably in the range of from 2.0 to 25 mol·dm⁻³, and most preferably in the range of from 5.0 to 10 mol·dm⁻³.

The total concentration of the one or more oxidation catalysts in the above chewing gum modifying composition is preferably in the range of from 0.005 to 0.5 mol·dm⁻³, and most preferably in the range of from 0.01 to 0.1 mol·dm⁻³.

The amount of the gelling agent in the above chewing gum modifying composition is preferably in the range of from 1 to 30 weight percent, more preferably from 1 to 20 weight percent and most preferably from 1 to 10 weight percent.

The amount of thickening agent in the above chewing gum modifying compositions is preferably in the range of from 0.01 to 100 g per litre, more preferably from 0.05 to 50 g per litre, and most preferably from 0.1 to 10 g per litre.

The amount of foaming agent in the above chewing gum modifying compositions is preferably in the range of from 0.01 to 100 g per litre, more preferably from 0.05 to 50 g per litre, and most preferably from 0.1 to 10 g per litre.

In a further preferred embodiment, the chewing gum modifying composition consists of an aqueous and/or alcoholic solution and/or suspension of one or more oxidising agents at a total concentration of from 1.0 to 50 mol·dm⁻³, which solution and/or suspension further includes from 1 to 30 weight percent of a gelling agent and from 0 to 10 weight percent of one or more additives selected from the group consisting of surfactants, pH modifiers, emulsifiers, colorants and wetting agents.

The total concentration of the one or more oxidising reagents in the above chewing gum modifying composition is preferably in the range of from 2.0 to 25 mol·dm⁻³, and most preferably in the range of from 5.0 to 10 mol·dm⁻³.

The amount of the gelling agent in the above chewing gum modifying composition is preferably from 1 to 20 weight percent and most preferably from 1 to 10 weight percent.

In a further preferred embodiment, the chewing gum modifying composition consists of an aqueous and/or alcoholic solution and/or suspension of one or more oxidising agents at a total concentration of from 1.0 to 50 mol·dm⁻³, which solution and/or suspension further includes from 1 to 30 weight percent of a gelling agent, from 0 to 100 g per litre of thickening agent, from 0 to 100 g per litre of foaming agent and from 0 to 10 weight percent of one or more additives selected from the group consisting of surfactants, pH modifiers, emulsifiers, colorants and wetting agents.

The total concentration of the one or more oxidising reagents in the above chewing gum modifying composition is preferably in the range of from 2.0 to 25 mol·dm⁻³, and most preferably in the range of from 5.0 to 10 mol·dm⁻³.

The amount of the gelling agent in the above chewing gum modifying composition is preferably from 1 to 20 weight percent and most preferably from 1 to 10 weight percent.

The amount of thickening agent in the above chewing gum modifying compositions is preferably from 0.01 to 100 g per litre, more preferably from 0.05 to 50 g per litre, and most preferably from 0.1 to 10 g per litre.

The amount of foaming agent in the above chewing gum modifying compositions is preferably from 0.01 to 100 g per litre, more preferably from 0.05 to 50 g per litre, and most preferably from 0.1 to 10 g per litre.

The present invention also provides a chewing gum modifying composition consisting of:
a) one or more oxidising agents as defined above;
b) one or more oxidation catalysts as defined above;
c) optionally one or more gelling agents, such as those defined above; and
d) optionally one or more additives, for example, those selected from the group consisting of surfactants, pH modifiers, emulsifiers, colorants and wetting agents.

In a further aspect, the present invention also provides a chewing gum modifying composition consisting of:
a) one or more oxidising agents as defined above;
b) one or more oxidation catalysts as defined above;
c) optionally one or more gelling agents, such as those defined above; and
d) optionally one or more thickening agents, such as those defined above;
e) optionally one or more foaming agents, such as those defined above; and
f) optionally one or more additives, for example, those selected from the group consisting of surfactants, pH modifiers, emulsifiers, colorants and wetting agents.

In a further aspect, the present invention provides a kit of parts for preparing a chewing gum modifying composition as defined above, the kit comprising;
(a) a first part comprising one or more oxidising agents; and
(b) a second part comprising one or more oxidation catalysts;
   wherein said one or more oxidising agents and said one or more oxidation catalysts are as defined above.

In accordance with this aspect of the invention, the kit of parts preferably further comprises a third part comprising one or more gelling agents as defined above. Alternatively or additionally, the kit of parts may comprise a fourth part comprising one or more thickening agents as defined above. Alternatively or additionally, the kit of parts may comprise a fifth part comprising one or more foaming agents as defined above.

In a further aspect, the present invention provides a kit of parts for preparing a chewing gum modifying composition as defined above, the kit comprising;
(a) a first part comprising one or more oxidising agents; and
(b) a second part comprising one or more gelling agents;
   wherein said one or more oxidising agents and said one or more gelling agents are as defined above.

In accordance with this aspect of the invention, the kit of parts preferably further comprises a third part comprising one or more thickening agents as defined above. Alternatively or additionally, the kit of parts may comprise a fourth part comprising one or more foaming agents as defined above.

The present invention further provides the use of a chewing gum modifying composition as defined above to remove chewing gum residues from substrates.

In another aspect, the present invention provides the use of an oxidising reagent as defined above to removing chewing gum residues from substrates, wherein said use does not comprise the step of applying an ionic liquid to a chewing gum residue.

The present invention is illustrated by way of the following examples.

### EXAMPLES

### Example 1

A chewing gum residue (˜0.5 g) on the surface of a concrete slab was covered with a layer of polyethylene imine gel (25% by weight in water, 0.5-0.7 mL) followed by hydrogen peroxide (35% by weight in water, 1 mL). The reaction commenced after approximately 1 minute. After 10 minutes the softened chewing gum residue could be mechanically removed from the surface of the concrete slab using a brush or spatula. If necessary, the procedure could be repeated to remove any remaining residue.

### Example 2

A potassium permanganate gel was prepared by combining fumed silica (10 g) with water (40 mL) and allowing the resulting mixture to stand for 5 minutes before adding mL of KMnO₄ dip [3.0 g KMnO₄, 20 g K₂CO₃, 5 mL aqueous NaOH (5 wt %), 300 mL water].

A chewing gum residue (˜0.5 g) on the surface of a concrete slab was covered with a layer of the potassium permanganate gel (0.2-0.5 g) followed by hydrogen peroxide (35% by weight in water, 1 mL). The reaction starts immediately. After 10 minutes the softened chewing gum residue could be mechanically removed from the surface of the concrete slab using a brush or spatula. If necessary, the reaction could be accelerated by applying KMnO₄ dip (1-1.5 mL) and H₂O₂ (35% by weight in water, 1-1.5 mL). The procedure can be repeated where necessary to remove any remaining residue.

### Example 3

Fe(AOT)₃ was prepared by mixing stoichiometric amounts of commercially-available Fe₂(SO₄)₃ and Na(AOT) in a mixture of ethanol and water (1:1 v/v). The mixture was held at 70° C. for 3 hours, then the precipitate was removed by filtration and the filtrate was concentrated in vacuo. The crude mixture was redissolved in ethanol and any further precipitate was removed before concentrating the filtrate in vacuo a second time.

A chewing gum residue (˜0.5 g) on the surface of a concrete slab was covered with a layer of Fe(AOT)₃ (0.5 g) followed by hydrogen peroxide (35% by weight in water, 1-1.5 mL). The reaction commenced after approximately 1 minute. After 15 minutes the softened chewing gum residue could be mechanically removed from the surface of the concrete slab using a brush or spatula. The reaction can be accelerated if necessary by the addition of additional Fe(AOT)₃ (0.5 g) or KMnO₄ dip as defined in Example 1 (0.5-1 mL). If necessary, the procedure could be repeated to remove any remaining residue.

### Example 4

Sodium silicate and sodium laureth sulfate were added to a solution comprising a peroxide as the oxidising agent and a permanganate as the oxidising catalyst. A synergistic effect was observed, with the viscosity of the of the resultant composition exceeding the viscosity of the foaming agent and thickening agent alone.

1. A method of modifying a chewing gum residue so as to ease removal of the chewing gum residue from a substrate, the method comprising applying to the chewing gum residue a chewing gum modifying composition comprising at least one oxidising reagent and at least one oxidation catalyst, wherein the chewing gum modifying composition does not comprise an ionic liquid.

2. A method according to claim 1, wherein the at least one oxidising reagent is selected from at least one member of a group consisting of: hydrogen peroxide, organic hydroperoxides, organic peroxyacids, organic peroxyacid salts, and dioxiranes.

3. A method according to claim 2, wherein the at least one oxidising reagent is selected from at least one member of a group consisting of: hydrogen peroxide, organic hydroperoxides having the formula ROOH, organic peroxyacids having the formula RCO₃H or salts thereof, wherein R is a C₁ to C₁₀ alkyl group or a C₆ to C₁₀ aryl group.

4. A method according to claim 3, wherein the at least one oxidising reagent is selected from at least one member of a group consisting of: hydrogen peroxide and tert-butyl hydroperoxide.

5. A method according to claim 4, wherein the oxidising reagent is hydrogen peroxide.

6. A method according to claim 1, wherein the at least one oxidation catalyst is are selected from at least one member of a group consisting of: lanthanide salts and transition metal salts.

7. A method according to claim 6, wherein the at least one oxidation catalyst is selected from at least one member of a group consisting of: Fe(II), Fe(III), Mn(VII), Mn(VI), Mn(IV), Mo(VI), Co(II), Zr(IV), Ce(IV), and Ni(II) salts.

8. A method according to claim 7, wherein the at least one oxidation catalyst is selected from at least one member of a group consisting of: Fe(III), Mn(VII), and Mn(IV) salt.

9. A method according to claim 8, wherein the at least one oxidation catalyst is selected from at least one member of a group consisting of: Fe(AOT)₃, FeCl₃, Fe₂(SO₄)₃, MnO₂, and KMnO₄.

10. A method according to claim 9, wherein the at least one oxidation catalyst is selected from at least one member of a group consisting of: Fe(AOT)₃ and KMnO₄.

11. A method according to claim 1, wherein the total concentration of the at least one oxidation catalyst in the chewing gum modifying composition is from 0.001 to 1.0 mol·dm⁻³.

12. A method according to claim 1, wherein the chewing gum modifying composition comprises at least one gelling agent.

13. A method according to claim 1, wherein the chewing gum modifying composition comprises at least one thickening agent.

14. A method according to claim 1, wherein the chewing gum modifying composition comprises at least one foaming agent.

15. A method of modifying a chewing gum residue so as to ease removal of the chewing gum residue from a substrate, the method comprising applying to the chewing gum residue a chewing gum modifying composition comprising at least one oxidising agent and at least one gelling agent, wherein the chewing gum modifying composition does not comprise an ionic liquid.

16. A method according to claim 15, wherein the chewing gum modifying composition further comprises at least one thickening agent.

17. A method according to claim 15, wherein the chewing gum modifying composition further comprises at least one foaming agent.

18. A method of modifying a chewing gum residue so as to ease removal of the chewing gum residue from a substrate, the method comprising applying to the chewing gum residue a chewing gum modifying composition comprising at least one oxidising reagent and at least one member of a group consisting of: at least one thickening agent and at least one foaming agent, wherein the chewing gum modifying composition does not comprise an ionic liquid.

19. A method according to claim 18, wherein the at least one oxidising reagent is selected from at least one member of a group consisting of: hydrogen peroxide, organic hydroperoxides, organic peroxyacids, organic peroxyacid salts, and dioxiranes.

20. A method according to claim 1, wherein the total concentration of the at least one oxidising reagent in the chewing gum modifying composition is in the range of from 1.0 to 50 mol·dm⁻³.

21. A method according to claim 1, wherein the chewing gum modifying composition is in the form of at least one member of a group consisting of: an aqueous solution, an alcoholic solution, and a suspension.

22. A method according to claim 1, wherein the chewing gum modifying composition has a viscosity in the range of 5,000 to 50,000 cP at 25° C.

23. A method according to claim 12, wherein the at least one gelling agent is selected from at least one member of a group consisting of: silica, alumina, clay, carbon, and organic polymers.

24. A method according to claim 23, wherein the at least one gelling agent is selected from at least one member of a group consisting of: fumed silica and polyethylene imine (PEI).

25. A method according to claim 13, wherein the at least one thickening agent is selected from at least one member of a group consisting of: polymer thickening agents and silicate thickening agents.

26. A method according to claim 14, wherein the at least one foaming agent is selected from anionic surfactants.

27. A method according to claim 1, wherein the chewing gum modifying composition further comprises at least one additive selected from at least one member of the group consisting of surfactants, pH modifiers, emulsifiers, colorants and wetting agents.

28. A method according to claim 1, wherein the chewing gum modifying composition is pre-mixed.

29. A method according to claim 1, wherein the chewing gum modifying composition is formed in situ.

30. A method according to claim 1, wherein the chewing gum residue is derived from a chewing gum comprising between 10 and 75% by weight of a gum base, wherein the gum base comprises between 5 and 80% by weight of at least one elastomer.

31. A method according to claim 30, wherein the gum base is derived from at least one member of a group consisting of: chicle, jelutong, sorva, gutta percha, gutta hang kang, niger gutta, gutta kataiu, chilte, chiquibul, massaranduba balata, massaranduba chocolate, nispero, leche, caspi and rosidinha.

32. A method according to claim 30, wherein the gum base comprises at least one synthetic elastomer selected from at least one member of a group consisting of: polyisoprene, polybutadiene, styrene-butadiene copolymers, polyisobutylene, polyvinylacetate, polyethylene, isobutylene-isoprene copolymer, vinyl acetate-vinyl laurate copolymer, crosslinked polyvinyl pyrrolidone, polymethylmethacrylate; copolymers of lactic acid, polyhydroxyalkanoates, plasticized ethylcellulose, and polyvinyl acetatephthalate.

33. A method according to claim 30, wherein the gum base comprises up to 50% by weight of at least one plasticizer, up to 20% by weight of at least one softener and up to 10% by weight of at least one wax.

34. A method according to claim 1, wherein the substrate comprises at least one member of a group consisting of: stone, concrete, cement, bricks, gypsum, plasterboard, clay, ceramic, glass, asphalt, tarmac, bitumen, metals, wood, varnish, lacquer and a textile.

35. A method according to claim 1, where the modified residue is subsequently removed from the substrate by at least one member of a group consisting of: sweeping, scrubbing, vacuuming, and hosing with low pressure water.

36. A chewing gum modifying composition, the composition comprising:
at least one oxidising reagent; and
at least one oxidation catalyst, wherein the chewing gum modifying composition does not comprise and ionic liquid.

37. A chewing gum modifying composition according to claim 36, wherein the chewing gum modifying composition comprises:
at least one member of a group consisting of: an aqueous solution, an alcoholic solution, and a suspension of the at least one oxidising agent at a total concentration of from 1.0 to 50 mol·dm⁻³;
at least one oxidation catalyst at a total concentration of from 0.001 to 1.0 mol·dm⁻³;
0 to 30 weight percent of a gelling agent and
0 to 10 weight percent of at least one additive selected from at least one member of a group consisting of: surfactants, pH modifiers, emulsifiers, colorants and wetting agents.

38. A chewing gum modifying composition according to claim 36, wherein the chewing gum modifying composition comprises:
at least one member of a group consisting of: an aqueous solution, an alcoholic solution, and a suspension of the at least one oxidising agent at a total concentration of from 1.0 to 50 mol·dm⁻³;
at least one oxidation catalyst at a total concentration of from 0.001 to 1.0 mol·dm⁻³;
0 to 30 weight percent of a gelling agent
0 to 100 g per litre of at least one member of a group consisting of: thickening agent and foaming agent and
0 to 10 weight percent of at least one additive selected from at least one member of a group consisting of: surfactants, pH modifiers, emulsifiers, colorants and wetting agents.

39. A chewing gum modifying composition according to claim 36, wherein the chewing gum modifying composition comprises:
at least one member of a group consisting of: an aqueous solution, an alcoholic solution, and a suspension of the at least one oxidising agent at a total concentration of from 1.0 to 50 mol·dm⁻³;
1 to 30 weight percent of a gelling agent and
0 to 10 weight percent of at least one additive selected from at least one member of a group consisting of: surfactants, pH modifiers, emulsifiers, colorants and wetting agents.

40. A chewing gum modifying composition according to claim 36, wherein the chewing gum modifying composition comprises:
at least one member of a group consisting of: an aqueous solution, an alcoholic solution, and a suspension of the at least one oxidising agent at a total concentration of from 1.0 to 50 mol·dm⁻³;
1 to 30 weight percent of a gelling agent
0 to 100 g per litre of at least one member of a group consisting of: thickening agent and foaming agent and
0 to 10 weight percent of at least one additive selected from at least one member of a group consisting of: surfactants, pH modifiers, emulsifiers, colorants and wetting agents.

41. A chewing gum modifying composition according to claim 36, wherein the chewing gum modifying composition comprises:
at least one member of a group consisting of: an aqueous solution, an alcoholic solution, and a suspension of the at least one oxidising agent at a total concentration of from 1.0 to 50 mol·dm⁻³.
0 to 100 g per litre of at least one member of a group consisting of: thickening agent and foaming agent; and
0 to 10 weight percent of at least one additive selected from at least one member of a group consisting of: surfactants, pH modifiers, emulsifiers, colorants and wetting agents.

42. A chewing gum modifying composition comprising:
at least one oxidising reagent; and
at least one oxidation catalyst, wherein the oxidation catalyst is selected from at least one member of a group consisting of: lanthanide salts and transition metal salts.

43. (canceled)

44. A kit of parts for preparing a chewing gum modifying composition, the kit comprising;
(a) a first part comprising at least one oxidizing agent; and
(b) a second part comprising at least one oxidation catalyst.

45. A kit of parts according to claim 44, further comprising a third part comprising at least one gelling agent.

46. A kit of parts according to claim 45, further comprising a fourth part comprising at least one thickening agent.

47. A kit of parts according to claim 46, further comprising a fifth part comprising at least one foaming agent.

48. A kit of parts for preparing a chewing gum modifying composition, the kit comprising;
(a) a first part comprising at least one oxidising agent; and
(b) a second part comprising at least one gelling agent.

49. (canceled)

50. (canceled)
